(19) United States
(12) Patent Application Publication
(10) Pub. No.: US 2025/0200374 A1
(43) Pub. Date: Jun. 19, 2025

(54) Transformer models with optimized first layer

(71) Applicant: Nils Graef, Dublin, CA (US)

(72) Inventor: Nils Graef, Dublin, CA (US)

(21) Appl. No.: 18/981,598

(22) Filed: Dec. 15, 2024

Related U.S. Application Data
(60) Provisional application No. 63/611,119, filed on Dec. 16, 2023.

(51) Int. Cl. G06N 3/082; G06N 3/045

(52) U.S. Cl. CPC G06N 3/082; G06N 3/045

(57) ABSTRACT

This specification discloses systems and methods for enhancing the efficiency of transformer models during inference and training by precomputing and storing in memory a significant portion of operations in the first transformer layer. The stored precomputed outputs are retrieved from memory during runtime, reducing computational complexity and memory bandwidth requirements. This approach results in decreased latency, increased throughput, and lower cost-per-token. The disclosed techniques are particularly advantageous for transformer models that incorporate positional encodings within the attention mechanism, such as Rotary Position Embedding (RoPE) and other relative position encoding schemes. The method of offline precomputing involves calculating the outputs of the eliminated operations and components for each of the original vocab_size embedding-vectors, where vocab_size is the size of the embedding vocabulary. One embodiment of the invention removes the feedforward network and the attention query, key, and value projections from the first transformer layer of the encoder and the decoder stacks.

### CROSS-REFERENCE TO RELATED APPLICATIONS

This application claims priority to the U.S. Provisional Application No. 63/611,119, filed on Dec. 16, 2023. The entire contents of the foregoing provisional application is hereby incorporated by reference.

### PRIOR ART

Ashish Vaswani, Noam Shazeer, et al., “Attention is all you need,” Advances in neural information processing systems, 2017. arXiv 1706.03762.
Jianlin Su, et al., “RoFormer: Enhanced Transformer with Rotary Position Embedding,” arXiv 2104.09864, 2021.
Ruibin Xiong, et al., “On Layer Normalization in the Transformer Architecture,” arXiv 2002.04745, 2020.
Noam Shazeer, “Fast transformer decoding: One write-head is all you need,” arXiv 1911.02150, 2019.
Joshua Ainslie, et al., “GQA: Training Generalized Multi-Query Transformer Models from Multi-Head Checkpoints,” arXiv 2305.13245, 2023.
Wang, B. and Komatsuzaki, “A. GPT-J-6B: A 6 billion parameter autoregressive language model”, Wikipedia https://en.wikipedia.org/wiki/GPT-J, 2021.
Alec Radford, et al., “Robust speech recognition via large-scale weak supervision,” arXiv 2212.04356, 2022.
Stella Biderman, et al., “Pythia: A suite for analyzing large language models across training and scaling,” arXiv 2304.01373, 2023.
Aakanksha Chowdhery, et al., “PaLM: Scaling language modeling with Pathways,” arXiv 2204.02311, 2022.
Hugo Touvron, et al., “Llama 2: Open foundation and fine-tuned chat models,” arXiv 2307.09288, 2023.
Albert Q Jiang, et al., “Mistral 7B,” arXiv 2310.06825, 2023.
Albert Q Jiang, et al., “Mixtral of Experts,” arXiv 2401.04088, 2024.
Noam Shazeer, “GLU Variants Improve Transformer,” arXiv 2002.05202, 2020.
Shanda Li, et al., “Functional Interpolation for Relative Positions Improves Long Context Transformers,” arXiv 2310.04418v2, 2024.

### BACKGROUND OF THE INVENTION

This specification relates to artificial intelligence and machine learning, and more particularly to systems and methods for optimizing the inference and training process of transformer-based models.

Transformer neural networks form the foundation of various generative artificial intelligence (AI) models, including large language models (LLMs), large multimodal models (LMMs), small language models (SLMs), vision language models (VLMs), and diffusion models. These models often employ positional encoding within their attention mechanisms, such as Rotary Position Embedding (RoPE) or other relative positional encoding. However, the computational complexity and cost associated with inference and training of transformer models remain significant, particularly as model size increases.

### SUMMARY OF THE INVENTION

This specification describes systems and methods for improving the efficiency of inference and training of transformer models by precomputing a substantial portion of operations in the first layer of both the encoder stack and the decoder stack of the transformer model. By precomputing these operations, the computational complexity and memory read operations are reduced, leading to lower latency, higher throughput, and decreased cost-per-token.

The disclosed approach is particularly applicable to transformer models that deploy positional encoding inside the attention mechanism, such as RoPE (Rotary Position Embedding) and other relative position encodings. The degree of computational savings depends on the total number of layers in the model. For instance, models with a small number of layers, such as Whisper tiny with 4 layers, may achieve up to 25% savings in inference complexity, while deeper models, such as Mistral-7B with 32 layers, may realize approximately 3% overall savings.

### BRIEF DESCRIPTION OF DRAWINGS

FIG. 1 depicts the first layer of a transformer model with absolute positional encoding (PE).

FIG. 2 shows the first layer of a transformer with RoPE (Rotary Position Embedding).

FIG. 3 depicts the first layer of a transformer with RoPE and where the attention network is processed in parallel to the feedforward network (FFN), which is also known as “parallel transformer”.

FIG. 4 shows the first layer of a parallel transformer with precomputed FFN and attention projection layers Q (query), K (key), and V (value) according to the disclosed invention.

FIG. 5 provides a comparative illustration of the precomputing scheme for the first layer of a parallel transformer. Specifically, FIG. 5(a) shows the prior-art implementation, while FIG. 5(b) depicts the implementation that utilizes precomputing FFN and linear layers Q, K, and V.

FIG. 6 shows the first layer of a non-parallel transformer with precomputed attention projection layers Q, K, and V.

FIG. 7 provides a comparative illustration of the precomputing scheme for the first layer of a non-parallel transformer. Specifically, FIG. 7(a) shows the original transformer architecture with pre-normalization and absolute positional encoding (PE). FIG. 7(b) depicts a state-of-the-art transformer with RoPE, while FIG. 7(c) shows the precomputing scheme where one normalization layer and the attention projection layers Q, K, and V are precomputed.

FIG. 8 shows a table that lists configurations and number of weights for the transform models Pythia-6.9B, Mistral-7B, and Mixtral-8×7B.

FIG. 9 depicts a table that shows the memory read savings and memory size changes for the transformer models Pythia-6.9B, Mistral-7B, and a modified version of Mixtral-8×7B with parallel attention/FFN.

### DETAILED DESCRIPTION OF THE INVENTION

FIG. 1 shows the first layer of a state-of-the-art transformer. This architecture incorporates positional encoding (PE) applied immediately after the embedding layer and utilizes pre-normalization (instead of post-normalization), see for example Ruibin Xiong, et al., “On Layer Normalization in the Transformer Architecture,” arXiv 2002.04745, 2020. The depiction in FIG. 1 applies to both the encoder stack and decoder stack of the transformer architecture. In encoder-decoder configurations, the decoder stack additionally includes cross-attention layers. FIG. 1 uses the following dimensions and components, based on the type of attention such as multi-head attention (MHA), multi-query attention (MQA), and grouped-query attention (GQA):

Dimension d is the embedding dimension. And dimension e is the output dimension of the key (K) and value (V) linear layers, where e=d holds for MHA. For MQA, e=d/n_heads holds, where n_heads is the number of attention heads. And for GQA, e=d*n_kv_heads/n_heads holds, where n_kv_heads is the number of shared key-value heads.

Q, K, V, O are the linear layers for attention query, key, value, and output projections. The FFN (feed-forward network) is usually a two-layer MLP (multi-layer perceptron). Many LLMs such as Mistral and Llama 2 use a two-layer MLP with a GLU variant. And MoE models (mixture-of-experts) such as Mixtral use a switch FFN.

The embedding layer (see the box labeled “embedding” in FIG. 1) is implemented by a simple memory read operation, where the token-ID provides the read-address to read d values from the memory. For example, for an embedding dimension d=1024 and a vocabulary size of 50,000 tokens, the embedding memory has a size of 1024*50,000=51.2 million values (e.g. 51 MB if each value takes one byte).

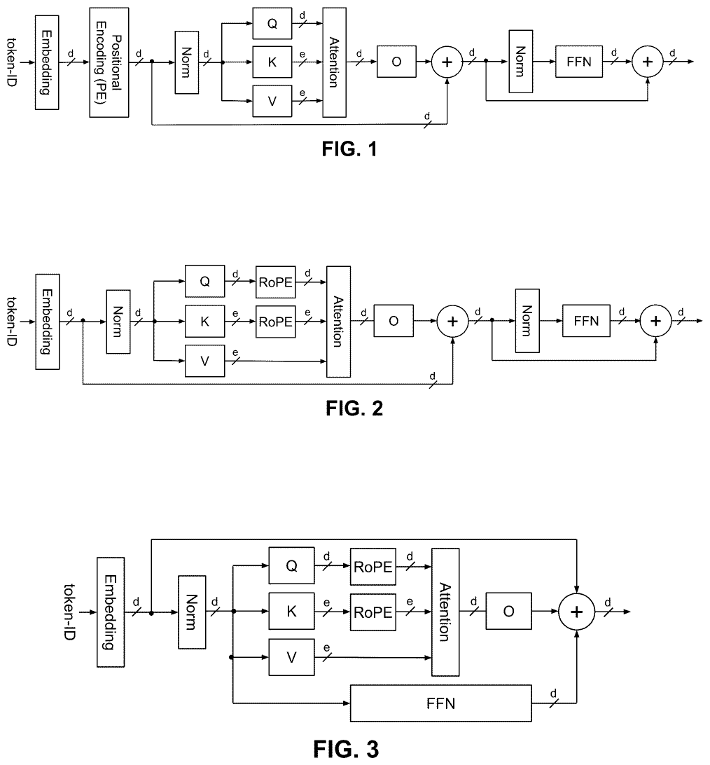

Many LLMs (such as Llama2, Mistral, and Mixtral) use ROPE instead of absolute positional encoding as illustrated in FIG. 2.

Some LLMs (such as GPT-J, Pythia, and PaLM) use ROPE in combination with having the attention network (including its projection layers) and FFN in parallel as shown in FIG. 3. Transformer models, which process the attention network and the FFN in parallel, are also known as “parallel transformers”, see for example Wang, B. and Komatsuzaki, “A. GPT-J-6B: A 6 billion parameter autoregressive language model.”

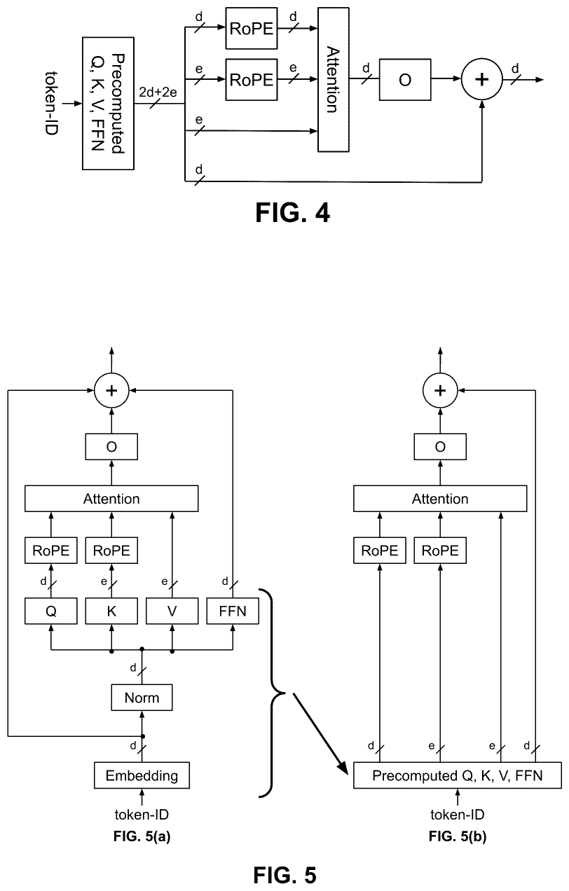

For transformers with RoPE and that use attention and FFN in parallel (referred to herein as “parallel transformers”), the removal of the absolute PE allows us to precompute the linear layers for Q, K, V and the FFN and store them in memory instead of the original input embeddings as shown in FIG. 4. This is possible because the inputs of Q, K, V, and FFN in FIG. 3 only depend on the embedding layer (and not on the positional encoding anymore).

This precomputing scheme eliminates the entire FFN block and the Q, K, V linear layers of the first layer. The only remaining projection layer of the first transformer-layer is the output projection layer (labeled O in FIG. 4), which usually has only d2 weights.

FIG. 5 illustrates the precomputing scheme by showing the state-of-the-art first layer of a parallel transformer next to the proposed scheme, where FIG. 5(a) is equivalent to FIG. 3 and FIG. 5(b) is equivalent to FIG. 4.

The precomputing is done as follows: For each of the k embedding-vectors originally stored in the embedding memory, perform the calculations needed for the first layer normalization (labeled “norm” in the figures), FFN, skip-connection (also known as residual connection), and the linear layers Q, K, V, and store the results in memory instead of the original input-embeddings. This precomputation is done off-line only once and the results are stored in the parameter memory (along with weights, biases and output-embeddings).

The benefits of the precomputing scheme described above are as follows: (1) Lower computational complexity per token: For each token, the operations needed for FFN and the linear layers Q, K, V of the first layer are not needed anymore. This can speed up inference for systems that are limited by compute. (2) Fewer memory reads for low batch sizes: This can speed up inference for systems that are memory bandwidth limited, especially during the autoregressive next-token-generation phase. The table below lists the number of memory reads for the first transformer layer with and without the precomputing scheme.

| | Without precompute | With precompute |
|---|---|---|
| | For each token, read d | For each token, |
| | embedding values | read 2 * (d + e) |
| | Plus, for each batch, read | precomputed |
| | weights for Q, K, V, and FFN | values |
| Reads per batch: | B * d + | B * 2 * (d + e) |
| (B is batch-size) | num_weights_Q_K_V_FFN | |

Specifically, as tabulated in the table above, the number of values read from memory for a batch of B tokens during the autoregressive next-token-generation phase is reduced as follows:

Without precomputing Q, K, V and FFN, we need to read the following values: For each token, we need to read d values from the embedding memory. In addition, for each batch, we need to read the weights for Q, K, V, and FFN of the first layer. We need to read them only once and can share them among all B tokens of the batch, where B is the batch size.

On the other hand, the precomputing scheme only needs to read 2*(d+e) values per each token of the batch, so B*2*(d+e) values in total.

During the non-autoregressive prefill phase of inference, many implementations use a batch size larger than 1, because all input-tokens can be processed in parallel, even for single-user applications. During the autoregressive next-token-generation phase, single-user implementations use a batch size of 1 (or or a batch size of num_beams, where num_beams is the width of the beam search), while multi-user implementations might use batch sizes larger than 1. However, the maximum batch size during this phase can be limited by the total memory capacity as the number of KV-caches increases linearly with the batch size.

Many transformer implementations and systems store weights and embeddings in DRAM (such as external DDR memory or HBM) and are therefore memory bound (i.e. they are limited by the memory bandwidth) during the autoregressive next-token-generation phase. Therefore, reducing the number of values read from memory speeds up the overall inference of the model resulting in lower latency, higher throughput, and higher energy efficiency.

However, precomputing components of the first layer can increase (or sometimes decrease) the total memory size, which depends on the vocabulary size and the number of eliminated weights as shown in the table below. For example, the total memory size of Mistral-7B only increases by 3%, see the examples at the end of this specification for more details.

| Without precompute | With precompute |
|---|---|
| Store embeddings: d * vocab_size | Store precomputed values: |
| Store weights for Q, K, V, and FFN | 2 * (d + e) * vocab_size |

The table above lists the memory size for the first transformer layer with and without the precomputing scheme. Specifically, the memory size is increased as follows, where vocab_size is the number of tokens in the vocabulary (e.g. 50,000 tokens): The embedding memory is widened from d to 2d+2e, so the absolute increase is vocab_size*(d+2e) values, where each value takes either 4 bytes (for 32-bit floating point) or 2 bytes (for 16-bit floating point) or 1 byte (for 8-bit floating point or fixed-point/integer) or even fewer bits (such as 4-bit for quantized models). On the other hand, we don't have to store in memory the weights of Q, K, V, and FFN of the first layer anymore, which saves d2 values for Q and 2 d e for K and V, and even more for the FFN.

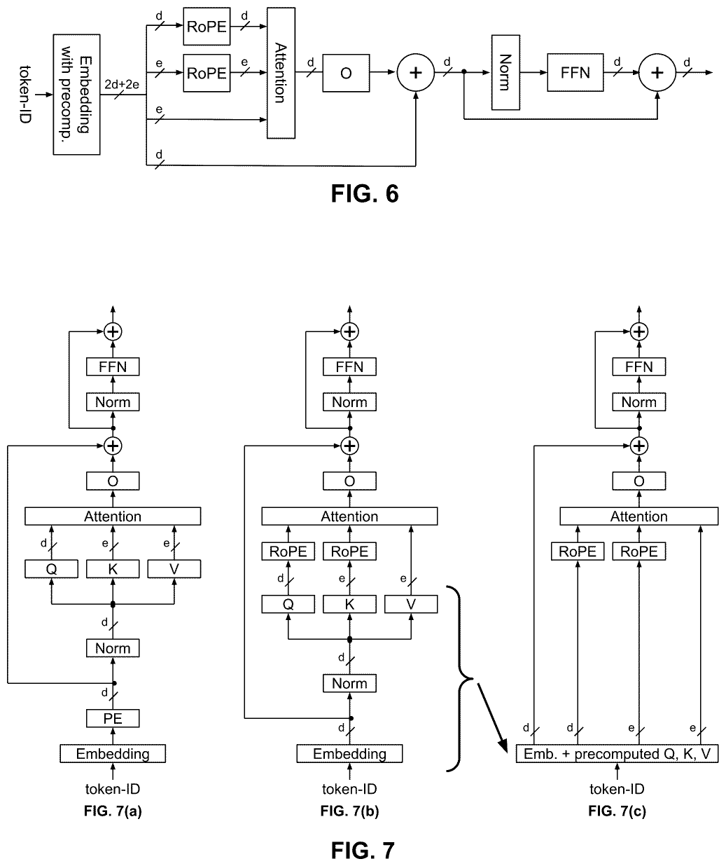

Transformers without the parallel attention/FFN scheme (also known as serial transformers) can also benefit from the proposed precomputation scheme, but the savings are smaller. As illustrated in FIG. 6, we can only precompute Q, K, and V, but not the FFN.

For serial transformers, FIG. 7 illustrates the precomputing scheme by showing the state-of-the-art first layer next to the proposed scheme, where FIG. 7(a) is equivalent to FIG. 1, FIG. 7(b) is equivalent to FIG. 2, and FIG. 7(c) is equivalent to FIG. 6. Specifically, FIG. 7(a) shows the original transformer with absolute positional encoding (PE) instead of ROPE and with pre-normalization. The PE is located immediately after the embedding layer, which prevents us from precomputing parts of the first layer. Replacing the absolute PE by ROPE, as done in FIG. 7(b), allows us to precompute the linear layers Q, K, and V and store the precomputed values along the embeddings in memory as illustrated in FIG. 7(c).

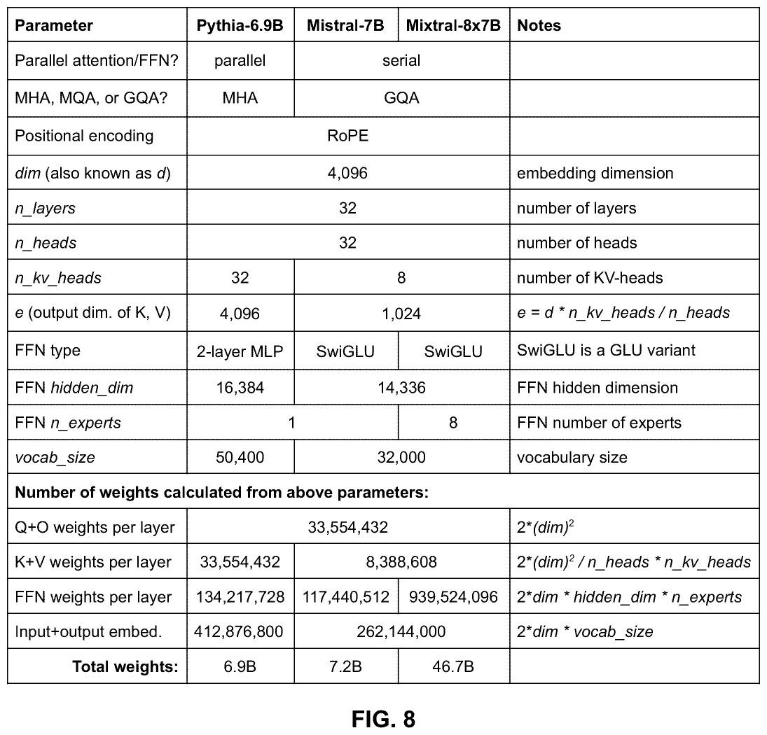

The table in FIG. 8 shows practical examples and compares the configurations and number of weights of the transformer models Pythia-6.9B, Mistral-7B, and Mixtral-8×7B.

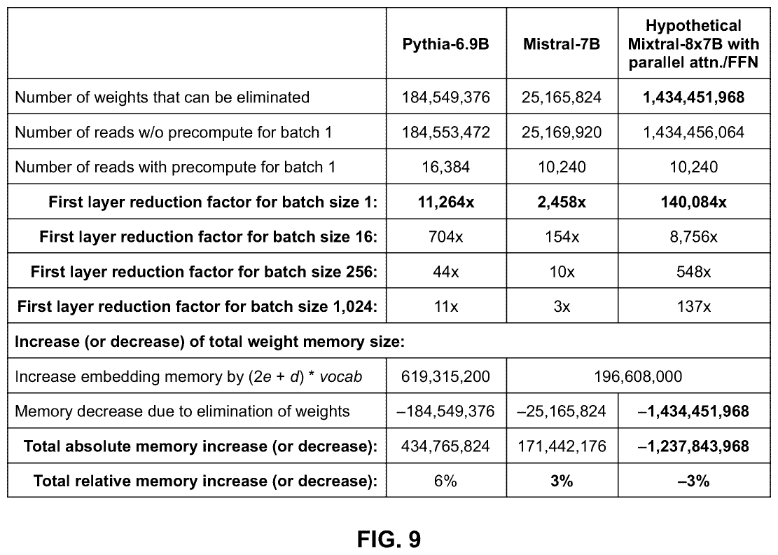

The table in FIG. 9 shows the memory read savings and memory size increases for Pythia-6.9B, Mistral-7B, and a hypothetical Mixtral-8×7B with parallel attention/FFN layers (note that the actual Mixtral-8×7B model doesn't use parallel attention/FFN layers but serialized ones).

The disclosed invention is applicable to all types of transformer models, including encoder-only (such as BERT), decoder-only (such as GPT), and encoder-decoder configurations (such as T5 models and Whisper models). For encoder-decoder transformers, the disclosed systems and methods can be applied to both the first layer of the encoder stack and the first layer of the decoder stack.

The removal of components from the first transformer layer can already be done before training of the neural network to reduce computational complexity during the training process. In this case, the process of precomputing values before inference is not needed anymore as both inference and training are using the exact same neural network architecture wherein the first layer has components removed.

Furthermore, the disclosed invention is not limited to any particular type of attention mechanism, feedforward network, or positional encoding scheme. Specifically, any type of attention network is supported, such as multi-head attention (MHA), multi-query attention (MQA), grouped-query attention (GQA), and differential attention. And any type of feedforward network is supported, including switch networks, mixture of experts (MoE), and single-layer perceptrons. And furthermore, the disclosed methods and systems are applicable to any transformer architecture that doesn't have a positional encoding mechanism located between the embedding layer and the projection layers of the first transformer block, which includes (without limitations) relative positional encoding such as ROPE, RPE of the T5 model, Alibi, Kerple, and FIRE, as well as transformers without any positional encoding schemes (also known as NoPE), see for example Shanda Li, et al., “Functional Interpolation for Relative Positions Improves Long Context Transformers,” arXiv 2310.04418v2, 2024.

1. A method for reducing computational complexity and a system comprising one or more computers and one or more storage devices storing instructions that when executed by the one or more computers implement a modified transformer neural network (including encoder-only, decoder-only, and encoder-decoder architectures) comprising of one or more input embedding tables (also known as embedding layers) and one or more transformer blocks (also known as transformer layers); wherein each transformer block comprises an attention network and a feedforward network; wherein each transformer block further comprises a parallel configuration (instead of a serial configuration) of the attention network and feedforward network where the inputs of the attention network and the feedforward network are both connected to the input of the transformer block, and the outputs of the two networks are element-wise added and the resulting sums constitute the outputs of the transformer block;
wherein the first transformer block (also known as first transformer layer) is modified by:
(a) removing at least one component from the first transformer block, and
(b) replacing the removed component with precomputed values stored in the embedding table, such that the precomputed values are utilized during the operation of the system to reduce computational complexity without compromising model accuracy; wherein the removed components include a feedforward network, the attention query (Q), key (K), and value (V) projection layers, a skip connection (also known as residual layer), and an optional preceding normalization layer; and wherein the method of offline precomputing involves calculating the outputs of said removed components for each of the original vocab_size embedding vectors, where vocab_size is the size of the embedding vocabulary.

2. The system of claim 1, wherein the modified transformer model uses an encoder-decoder transformer architecture comprising an encoder stack and a decoder stack, each configured with a plurality of transformer blocks; wherein the first transformer block of the encoder stack and the first transformer block of the decoder stack are modified by:
(a) removing at least one component from each of the respective first transformer blocks, and
(b) replacing the removed component with precomputed values stored in corresponding embedding tables,
such that the precomputed values are utilized during the operation of the system to reduce computational complexity without compromising model accuracy.

3. The system of claim 1, wherein the removal of components of the first transformer block is already done before training of the neural network to reduce computational complexity without compromising model accuracy and to eliminate the process of offline precomputing values before inference.

4. The system of claim 1, wherein the modified attention network includes without limitations any type of attention network or mechanism, such as multi-head attention (MHA), multi-query attention (MQA), grouped-query attention (GQA), and differential attention.

5. The system of claim 1, wherein the eliminated feedforward network includes without limitations any type of feedforward network, such as mixture of experts (MoE), switch network, and single-layer perceptron.

6. The system of claim 1, wherein the positional encoding scheme includes any type of positional encoding that is not located between the embedding layer and the linear layers of the first transformer layer, such as RoPE (rotary position embedding), relative positional encoding schemes such as RPE of the T5 model, Alibi, Kerple, and FIRE, as well as no positional encoding scheme (also known as NoPE), see for example Shanda Li, et al., “Functional Interpolation for Relative Positions Improves Long Context Transformers,” arXiv 2310.04418v2, 2024.

7. A method for reducing computational complexity and a system comprising one or more computers and one or more storage devices storing instructions that when executed by the one or more computers implement a modified transformer neural network (including encoder-only, decoder-only, and encoder-decoder architectures) comprising of one or more input embedding tables (also known as embedding layers) and one or more transformer blocks (also known as transformer layers); wherein each transformer block comprises an attention network and a feedforward network; wherein each transformer block further comprises a serial configuration (instead of a parallel configuration) of the attention network and feedforward network; wherein the first transformer block (also known as first transformer layer) is modified by:
(a) removing at least one component from the first transformer block, and
(b) replacing the removed component with precomputed values stored in the embedding table, such that the precomputed values are utilized during the operation of the system to reduce computational complexity without compromising model accuracy; wherein the removed components include the attention query (Q), key (K), and value (V) projection layers and an optional preceding normalization layer; and wherein the method of offline precomputing involves calculating the outputs of said removed components for each of the original vocab_size embedding vectors, where vocab_size is the size of the embedding vocabulary.

8. The system of claim 7, wherein the modified transformer model uses an encoder-decoder transformer architecture comprising an encoder stack and a decoder stack, each configured with a plurality of transformer blocks; wherein the first transformer block of the encoder stack and the first transformer block of the decoder stack are modified by:
(a) removing at least one component from each of the respective first transformer blocks, and
(b) replacing the removed component with precomputed values stored in corresponding embedding tables,
such that the precomputed values are utilized during the operation of the system to reduce computational complexity without compromising model accuracy.

9. The system of claim 7, wherein the removal of components of the first transformer block is already done before training of the neural network to reduce computational complexity without compromising model accuracy and to eliminate the process of offline precomputing values before inference.

10. The system of claim 7, wherein the modified attention network includes without limitations any type of attention network or mechanism, such as multi-head attention (MHA), multi-query attention (MQA), grouped-query attention (GQA), and differential attention.

11. The system of claim 7, wherein the positional encoding scheme includes any type of positional encoding that is not located between the embedding layer and the linear layers of the first transformer layer, such as RoPE (rotary position embedding), relative positional encoding schemes such as RPE of the T5 model, Alibi, Kerple, and FIRE, as well as no positional encoding scheme (also known as NoPE), see for example Shanda Li, et al., “Functional Interpolation for Relative Positions Improves Long Context Transformers,” arXiv 2310.04418v2, 2024.
